(19) United States
(12) Patent Application Publication
(10) Pub. No.: US 2008/0187232 A1
(43) Pub. Date: Aug. 7, 2008

(54) Picture reproducing and displaying apparatus and method

(75) Inventors: Takane Koizumi, Tokyo (JP); Shinji Sakai, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/012,065

(22) Filed: Jan. 31, 2008

(30) Foreign Application Priority Data
Feb. 2, 2007 (JP) P2007-024394

(51) Int. Cl. G06K 9/36

(52) U.S. Cl. 382/233; 382/256; 375/240.26

(57) ABSTRACT

According to an embodiment of the present invention, there is provided a picture reproducing and displaying apparatus which displays a compression-encoded picture on a display section. A first memory stores input encoded picture data. A decoding section decodes the input encoded picture data stored in the first memory. A second memory in which one of a first development area whose size larger than that of a display area of a display picture and a second development area whose size smaller than that of the first development area is capable of being set in the second memory. A second memory stores a picture decoded by the decoding section. A display section displays a picture developed in the second memory. A control section controls the decoding section and the second memory according to one of a picture quality priority mode and a speed priority mode.

### CROSS REFERENCES TO RELATED APPLICATIONS

The present invention contains subject matter related to Japanese Patent Application JP 2007-024394 filed in the Japanese Patent Office on Feb. 2, 2007, the entire contents of which being incorporated herein by reference.

### BACKGROUND OF THE INVENTION

1. Field of the Invention

The present invention relates to a picture reproducing and displaying apparatus and a method thereof used to display pictures stored in a record medium, for example, a memory card, on a screen of a television receiver.

2. Description of the Related Art

In recent years, it has been common that a television receiver has a memory card slot, pictures captured by a digital still camera are stored in the memory card, the memory card is attached to the memory card slot of the television receiver, and the captured pictures are displayed on a large screen of the television receiver. The display screens of the television receivers are, for example, based on the HD (High Definition) 1920×1080 pixel specifications. Recently, the resolutions of digital still cameras have increased and products having a resolution in excess of 10 million pixels have been released.

When captured pictures having a very large number of pixels are displayed, because of the restriction of the memory capacity, compression-encoded data, for example, JPEG (Joint Photographic Experts Group) data are decoded by a size reduction decoding technique. For example, Japanese Patent Application Laid-Open No. 2005-235029 (referred to as the patent document 1) describes that thumbnail pictures are created by a size reduction decoding technique.

The reduction decoding technique is a method, for example, of which only a DC (Direct Current) component and low frequency side AC (Alternate Current) components are extracted from a JPEG picture that has been encoded in the unit of a (8×8) DCT (Discrete Cosine Transform) block. When (4×4) blocks composed of a DC component and low frequency side AC components are structured and decoded, a (4×4) decoded picture can be obtained. In this case, a ½-reduced decoded picture is obtained. When (2×2) blocks are structured and decoded, a ¼-reduced decoded picture is obtained. When only a DC component is used, a ⅛-reduced decoded picture is obtained.

### SUMMARY OF THE INVENTION

In the reduction decoding technique, the lager the size reduction rate is, the more the picture quality deteriorates. To solve this problem, it is necessary to increase the capacity of the memory that stores decoded pictures and thereby increase the development area. The increase of the capacity of the memory results in an increase of the cost. On the other hand, when the picture quality is improved with an increase of the capacity of the memory, in addition to the increase of the cost, since the number of pixels of each picture is large, it takes a long time to read encoded data and to decode the encoded data. Thus, it takes a long time after the user selects his or her desired picture until the selected picture is displayed on the screen.

In view of the foregoing, it would be desirable to provide a picture reproducing and displaying apparatus and a method thereof that allow the user to set one of a picture quality priority mode and a speed priority mode so as to solve a problem of a long waiting time until a picture is displayed or a problem of which displayed pictures deteriorate.

According to an embodiment of the present invention, there is provided a picture reproducing and displaying apparatus which displays a compression-encoded picture on a display section. The picture reproducing and displaying apparatus includes a first memory, a decoding section, a second memory, a display section, and a control section. The first memory stores input encoded picture data. The decoding section decodes the input encoded picture data stored in the first memory. The second memory in which one of a first development area whose size larger than that of a display area of a display picture and a second development area whose size smaller than that of the first development area is capable of being set in the second memory. The second memory stores a picture decoded by the decoding section. The display section displays a picture developed in the second memory. The control section controls the decoding section and the second memory according to one of a picture quality priority mode and a speed priority mode. In the picture quality priority mode, the control section controls the decoding section to perform a size conversion process of converting decoded picture within a size of the display section so as to decode the input encoded picture data in an equal size when the picture size of the input encoded picture data is smaller than a size of the first development area and decode the input encoded picture data in a reduced size when the picture size of the input encoded picture data is larger than the size of the first development area. In the speed priority mode, the control section sets the second development area and controls the decoding section to perform the size conversion process of converting the decoded picture within the size of the display section so as to decode the input encoded picture data in the equal size when the picture size of the input encoded picture data is smaller than a size of the second development area, and decode the input encoded picture data in a reduced size when the picture size of the input encoded picture data is larger than the size of the second development area.

According to an embodiment of the present invention, there is provided a picture reproducing and displaying method of displaying a compression-encoded picture on a display section. A first development area and a second development area whose size is smaller than that of the first development area are set when a picture quality priority mode and a speed priority mode are designated, respectively. A size of the first development area or the second development area that has been set and a picture size of the input encoded picture data are compared. A size reduction rate of a decoding section is set such that the picture size of the input encoded picture becomes equal to or smaller than the size of the development area which has been set. The input encoded picture is decoded at the size reduction rate which has been set. The picture that has been decoded at the decoding step is displayed on the display section.

According to embodiments of the present invention, with one of reproduction quality and decoding time prioritized, pictures are reproduced and displayed. Since the user can set either of the picture quality priority mode and the speed priority mode, when the decoding time becomes long in the picture quality priority mode, since he or she can recognize the situation as the result of the selection of the picture quality priority mode, he or she can be prevented from being suspicious about the long decoding time. Likewise, even if the quality of reproduced pictures deteriorates, since the user can recognize the situation as the result of the selection of the speed priority mode, he or she can accept the situation.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a block diagram showing the structure of a picture reproducing and displaying apparatus according to an embodiment of the present invention;

FIG. 2 is a flow chart describing a flow of an operation of the picture reproducing and displaying apparatus according to an embodiment of the present invention;

FIG. 3 is a schematic diagram showing an example of a screen display used to describe a mode setting method according to an embodiment of the present invention;

FIG. 4 is a schematic diagram showing a flow of a process of a picture quality priority mode according to an embodiment of the present invention; and

FIG. 5 is a schematic diagram showing a flow of a process of a speed priority mode according to an embodiment of the present invention.

### DETAILED DESCRIPTION OF THE PREFERRED EMBODIMENTS

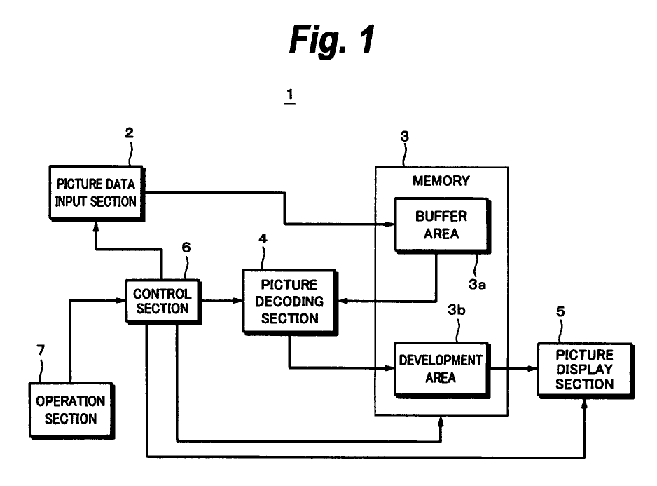

Next, embodiments of the present invention will be described. FIG. 1 shows the structure of a picture reproducing and displaying apparatus 1 according to an embodiment of the present invention. The picture reproducing and displaying apparatus 1 is accomplished as a part of functions of, for example, a digital television receiver.

Encoded picture data are input through a picture data input section 2 and supplied to a buffer area 3a as a first memory of a memory 3. The input encoded picture data are picture data that have been compressed according to the JPEG system. Hereinafter, the input encoded picture data are simply referred to as a JPEG picture (data). The buffer area 3a and a development area 3b as a second memory are composed by dividing the memory 3. Instead, independent memories may be used for the buffer and development.

A picture data input section 2 is a slot to which for example a memory card is attached. Instead, the picture data input section 2 may be a wired or wireless interface. Examples of the wired interface include a wired LAN (Local Area Network) and IEEE (Instituted of Electrical and Electronics Engineers) 1394. Examples of the wireless interface include the Bluetooth (registered trademark), a wireless LAN, and UWB (Ultra Wide Band). Content data are transferred (streamed) and content management data are transferred through the interface.

A JPEG picture stored in the buffer area 3a is decoded by a picture decoding section 4. The picture decoding section 4 decodes the JPEG picture by one of an equal-size decoding technique and a size reduction decoding technique. The picture decoding section 4 is composed of hardware or software. A picture decoded by the picture decoding section 4 (this picture is referred to as a decoded picture) is stored in the development area 3b of the memory 3. A picture that is output from the development area 3b (this picture is referred to as a display picture) is displayed by a picture display section 5. The picture display section 5 is an FPD (Flat Panel Display) such as an LCD (Liquid Crystal Display) or a PDP (Plasma Display Panel) and is incorporated into the television receiver.

The whole picture reproducing and displaying apparatus 1 is controlled by a control section 6. The control section 6 is composed of a CPU (Central Processing Unit), a ROM (Read Only Memory), a RAM (Random Access Memory), and so forth. The ROM pre-stores both a program that operates on the CPU and data with which the software operates. The RAM is used as a work memory of the CPU. When necessary, the CPU reads the program and data stored in the ROM and controls each section of the picture reproducing and displaying apparatus 1 while using the RAM as the work memory.

Connected to the control section 6 is an operation section 7. The operation section 7 is composed of keys, a remote controller commander, and so forth that the user operates. The operation section 7 is structured as a GUI (Graphic User Interface) that uses, for example, the screen display of the television receiver. Disposed in the operation section 7 is a setting means to set one of the picture quality priority mode and the speed priority mode.

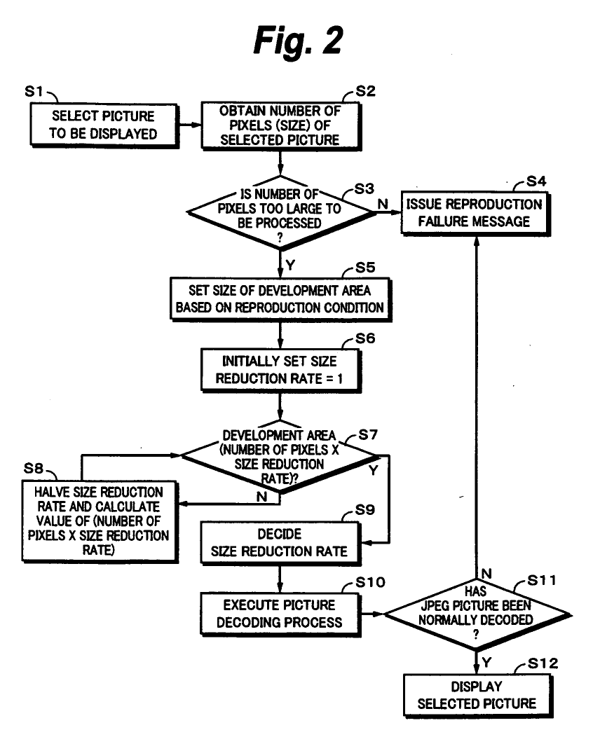

Next, with reference to a flow chart shown in FIG. 2, a control operation performed by the control section 6 of the picture reproducing and displaying apparatus 1 will be described. For example, a memory card is attached to the picture data input section 2. A JPEG file is read from the memory card and stored in the buffer area 3a of the memory 3. A JPEG file captured by a digital camera is regularly created as an Exif (Exchangeable image file format for digital still camera) format file to which a thumbnail picture, capturing information and so forth are added. The control section 6 obtains these types of information.

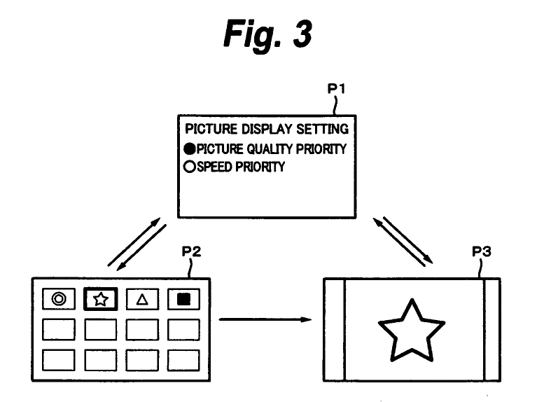

As shown in FIG. 3, a picture display setting menu P1 is displayed, for example, on the display screen (picture display section 5) of the television receiver. With up and down keys of the remote control commander, the user selects one of the picture quality priority mode and the speed priority mode. When one of the modes has been selected, thumbnail pictures contained in the JPEG file are displayed as a selection screen P2 on the display screen.

The user selects his or her desired picture with directional keys of the remote control commander. The selected picture is displayed, for example, with a colored frame, a highlighted frame, or the like that can be distinguished from other pictures. After the desired picture has been selected on the selection screen P2, a confirmation button of the remote control commander is operated and a picture P3 corresponding to the selected thumbnail is displayed on the display screen.

The picture display setting menu screen P1 can be invoked from any of the state in which the selection screen P2 of thumbnail pictures is displayed and the state in which the selected picture P3 is displayed with keys of the remote control commander or the like.

In the flow chart shown in FIG. 2, as described above, step S1 represents a process of selecting a desired picture on the selection screen P2. At step S2, the number of pixels of the selected picture is obtained from the JPEG picture data. The numbers of pixels of pictures correspond to their sizes thereof. Thus, the larger the number of pixels of a picture, the larger the size thereof. The picture display section 5 can display a picture having an aspect ratio of (16:9). In digital cameras, the aspect ratio of a picture is generally (4:3).

When the number of pixels of the picture that has been selected is too large to be processed, the flow advances to step S4. At step S4, the user is informed of a reproduction fail message. For example, a message that denotes that the selected picture is not able to be normally reproduced is displayed. Instead of the message that is displayed, an audio message may be generated.

When the determined result at step S3 denotes that the number of pixels of the selected picture can be processed, the development area 3b of the memory 3 is set to a first development area or a second development area that differ in the number of pixels (size) on the basis of the reproduction condition. As described above, the reproduction condition represents one mode that has been set on the picture display setting menu screen P1. In other words, when the picture quality priority mode has been selected, the first development area is set. In contrast, when the speed priority mode has been selected, the second development area that is smaller than the first development area is set.

At step S6, the size reduction rate of the picture decoding section 4 is initially set to 1, namely equal size. At step S7, the number of pixels of the development area that has been set at step S5 and the value of (number of pixels×size reduction rate), namely the number of pixels of the obtained decoded picture, are compared. When the determined result denotes that the number of pictures of the development area is equal to or larger than the number of pixels of the decoded picture, the flow advances to step S9. At step S9, the size reduction rate is decided.

After the size reduction rate has been decided, the flow advances to step S10. At step S10, a decoding process for the JPEG picture is executed. At step S11, it is determined whether or not the JPEG picture has been normally decoded. When the determined result denotes that the JPEG picture has been normally decoded, the flow advances to step S12. At step S12, the selected picture is displayed. When the selected picture is displayed, a size conversion process for the decoded picture is performed such that the decoded picture matches the screen size of the picture display section 5. At this point, the decoded picture is displayed without changing the aspect ration thereof.

When the determined result at step S7 denotes that the number of pixels of the development area is smaller than the value of (number of pixel×size reduction rate), the flow advances to step S8. At step S8, the size reduction rate is halved and the value of (number of pixels×size reduction rate) is calculated. Thereafter, the flow returns to step S7. At step S7, the number of pixels of the development area and the value of (number of pixels×size reduction rate) are compared again. When the number of pixels of the development area is still smaller than the value of (number of pixels×size reduction rate), the flow advances to step S8. At step S8, the size reduction rate is further halved and the value of (number of pixel×size reduction rate) is calculated. The flow returns to step S7. At step S7, the number of pixels of the development area and the value of (number of pixels×size reduction rate) are compared again. When the number of pixels of the development area is still smaller than the value of (number of pixels×size reduction rate), the flow advances to step S8. At step S8, the size reduction rate is further halved and the value of (number of pixels×size reduction rate) is calculated. The flow advances to step S7. At step S7, the number of pixels of the development area and the value of (number of pixels×size reduction rate) are compared again.

In the JPEG system, the size reduction decoding can be performed by changing the size reduction rate, for example, to ½, ¼, and ⅛. In the case of the JPEG system, a JPEG picture is composed of (8×8) DCT coefficients (one DC component and 63 AC components). When AC coefficients on the high frequency side of a JPEG picture are removed, a block of (4×4) coefficients is formed as the remaining coefficients, and the block is decoded, the size of the decoded picture is reduced to ½. When a block of (2×2) coefficients is decoded, the size of the decoded picture is reduced to ¼. When only the DC component is decoded, the size of the decoded picture is reduced to ⅛. The higher the size reduction rate is, the shorter the decoding time is.

When the determined result at step S11 denotes that the JPEG picture has not been normally decoded, the flow returns to step S4. At step S4, the process of informing the user of the reproduction failure message is performed.

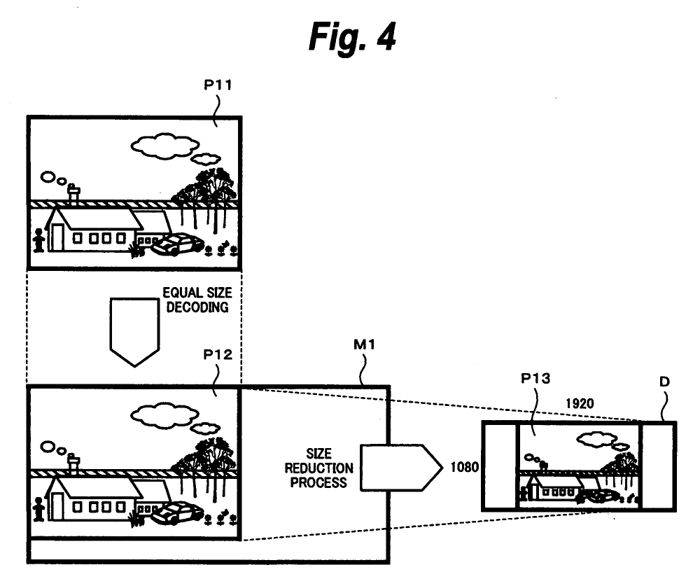

FIG. 4 shows a flow of the picture process in the picture quality priority mode. In FIG. 4, M1 represents the first development area that has been set at step S5, and D represents the display area of the picture display section 5. The display area is, for example, based on the HD 1920×1080 pixel specifications. In the picture quality priority mode, the number of pixels in the first development area M1 that has been set to the development area 3b of the memory 3 (3840×2160 pixels) is nearly two times larger than the length and width of the display area D.

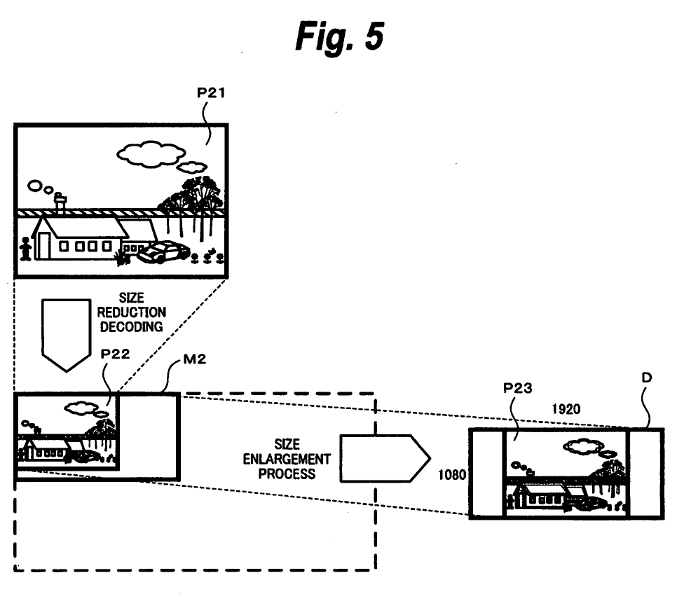

FIG. 5 shows a flow of the picture process in the speed priority mode. In FIG. 5, M2 represents the development area that has been set at step S5, and D represents the display area of the picture display section 5. The display area is, for example, 1920×1080 pixels. In the speed priority mode, the number of pixels of the second development area M2 that has been set to the development area 3b of the memory 3 is smaller than that of the first development area M1. For example, the number of pixels of the second development area M2 is smaller than that of the display area D.

In the example of the process in the picture quality priority mode shown in FIG. 4, since the number of pixels (size) of a selected picture P11 is smaller than that of the development area M1, the size reduction rate is set to 1 (equal size), the selected picture P11 is decoded with the size reduction rate, and a decoded picture P12 is obtained at step S9. The decoded picture P12 is developed in the development area M1. A reduced display picture P13 is displayed in the display area D such that the decoded picture P12 matches the size of the display screen. The size reduction process of reducing the decoded picture P12 to the display picture P13 whose number of pixels is smaller than that of the decoded picture P12 has an advantage of which the picture quality does not deteriorate in comparison with the size enlargement process when the size reduction rate is not high.

Unlike the example shown in FIG. 4, in the picture quality priority mode, the number of pixels (size) of the selected picture P11 may be larger than that of the development area M1. In this case, the selected picture P11 is decoded by a size reduction technique. However, since the development area M1 has a sufficient number of pixels, the possibility of which the selected picture P11 is decoded with a high size reduction rate can be decreased. As a result, the deterioration of the display picture P13 can be decreased.

In an example of the process in the speed priority mode shown in FIG. 5, since the number of pixels of a selected picture P21 is larger than that of the development area M1, the size reduction rate is set to ½, ¼, or ⅛, the selected picture P21 is decoded with the size reduction rate, and a decoded picture P22 is obtained at step S9. The decoded picture P22 is developed in the development area M2. An enlarged decoded picture P23 is displayed in the display area D such that the decoded picture P22 matches the size of the display screen.

In the size enlargement process of enlarging the decoded picture P22 to the decoded picture P23 whose number of pixels is larger than that of the decoded picture P22, the picture quality of the decoded picture P23 deteriorates. As a result, the decoded picture P23 becomes a blurred picture. However, since the process time for the size reduction decoding process is shorter than that for the equal-size decoding process, the display time necessary after a picture to be displayed is selected until the decoded picture P23 is displayed can be decreased. Thus, in the speed priority mode, with a small number of pixels (small size) of the development area, the size reduction decoding process is performed. Thus, the process time after a picture is selected until the selected picture is displayed can be decreased.

It should be understood by those skilled in the art that various modifications, combinations, sub-combinations and alternations may occur depending on design requirements and other factors insofar as they are within the scope of the appended claims or the equivalents thereof. For example, in the foregoing embodiment, one of the picture quality priority mode and the speed priority mode is set by a user's manual operation (with the remote control commander). Instead, after one mode has been set, it may be automatically changed. For example, when the speed priority mode has been selected, if it can be anticipated that the decoding time will not become long due to picture size, file size, data transfer rate, and so forth, the speed priority mode may be switched to the picture quality priority mode such that the picture quality of the decoded picture is improved. Likewise, in the speed priority mode, if it can be anticipated that the picture quality will remarkably deteriorate, the size of the development area may be slightly increased.

In addition, according to the foregoing embodiment, still pictures may be displayed as a slide show. In this case, the normal display mode and the slide show mode may be commonly prioritized. Instead, the slide show may be specially prioritized.

In addition, an embodiment of the present invention can be applied to a viewer that displays pictures stored in a memory card as well as a television receiver. Moreover, any compression-encoding system instead of the JPEG system can be used as long as a size reduction decoding process can be performed and the decoding time can be decreased.

What is claimed is:

1. A picture reproducing and displaying apparatus which displays a compression-encoded picture on a display section, comprising:
a first memory which stores input encoded picture data;
a decoding section which decodes the input encoded picture data stored in the first memory;
a second memory in which one of a first development area whose size larger than that of a display area of a display picture and a second development area whose size smaller than that of the first development area is capable of being set and which stores a picture decoded by the decoding section;
a display section which displays a picture developed in the second memory; and
a control section which controls the decoding section and the second memory according to one of a picture quality priority mode and a speed priority mode,
wherein in the picture quality priority mode, the control section controls the decoding section to perform a size conversion process of converting decoded picture within a size of the display section so as to decode the input encoded picture data in an equal size when the picture size of the input encoded picture data is smaller than a size of the first development area and decode the input encoded picture data in a reduced size when the picture size of the input encoded picture data is larger than the size of the first development area, and
wherein in the speed priority mode, the control section sets the second development area and controls the decoding section to perform the size conversion process of converting the decoded picture within the size of the display section so as to decode the input encoded picture data in the equal size when the picture size of the input encoded picture data is smaller than a size of the second development area, and decode the input encoded picture data in a reduced size when the picture size of the input encoded picture data is larger than the size of the second development area.

2. The picture reproducing and displaying apparatus as set forth in claim 1, further comprising:
a designation section which designates one of the picture quality priority mode and the speed priority mode,
wherein a designated mode of the designation section is supplied to the control section.

3. The picture reproducing and displaying apparatus as set forth in claim 1, wherein mode switching is performed between the picture quality priority mode and the speed priority mode according to a file size of the input encoded picture data instead of the picture size of the input encoded picture data.

4. The picture reproducing and displaying apparatus as set forth in claim 1, wherein the size of the second development area is smaller than that of a display area of the display section.

5. The picture reproducing and displaying apparatus as set forth in claim 1, wherein the control section obtains the picture size of the input encoded picture data based on additional information of the input encoded picture data.

6. The picture reproducing and displaying apparatus as set forth in claim 1, wherein the decoding section decodes the input encoded picture data in one of reduction sizes of ½, ¼, and ⅛.

7. A picture reproducing and displaying method of displaying a compression-encoded picture on a display section, comprising the steps of:
setting a first development area and a second development area whose size is smaller than that of the first development area when a picture quality priority mode and a speed priority mode are designated, respectively;
comparing a size of the first development area or the second development area that has been set and a picture size of the input encoded picture data, setting a size reduction rate of a decoding section such that the picture size of the input encoded picture becomes equal to or smaller than the size of the development area which has been set, and decoding the input encoded picture at the size reduction rate which has been set; and
displaying the picture that has been decoded at the decoding step on the display section.
